(19) United States
(12) Patent Application Publication
(10) Pub. No.: US 2011/0010380 A1
(43) Pub. Date: Jan. 13, 2011

(54) Pet health management system

(76) Inventor: Jiunn-Rong Chen, Taichung City (TW)

Correspondence Address: CHARLES E. BAXLEY, ESQUIRE, 90 JOHN STREET, SUITE 403, NEW YORK, NY, 10038, US

(21) Appl. No.: 12/459,789

(22) Filed: Jul. 8, 2009

(51) Int. Cl. G06F 17/30

(52) U.S. Cl. 707/769; 119/174; 707/759; 707/723

(57) ABSTRACT

A pet health management system allows a pet owner to transmit image data of a pet to a care service provider so that the care service provider is enabled to preliminarily assess the pet's health conditions by observing the image data. Furthermore, the pet health management system allows the care service provider to deliver advice as feedback to the pet owner.

### BACKGROUND OF THE INVENTION

1. Technical Field

The present invention relates to a pet health management system whereby a care service provider (such as a veterinarian) at a remote site is provided with real-time information including images (dynamic or still images) and physical data related to a pet. As a result, the care service provider is allowed to provide advice according to his preliminarily assessment of the pet's health conditions based on the real-time information.

2. Description of Related Art

Cats, dogs, rabbits and fishes are popular family pets for they have strong emotional interaction with humans. However, while loving pets, most people seldom truly recognize correct and suitable pet-raising method and usually do not know much about pets' physical structure, diseases, and symptoms. Consequently, most pet owners can only provide to their pets with daily care and fail to consider about pet's health management and disease prophylaxis. Thus, the considerable medical expense for curing ill pets usually brings significant burdens to pet owners.

For providing appropriate and effective health management and disease prophylaxis for pets, cooperation between care service providers (such as veterinarians) and pet owners is necessary. However, problems about availability of care service providers, such as geographic distance and veterinarian-pet ratio, are the main practical challenges to pets' health management and disease prophylaxis.

### SUMMARY OF THE INVENTION

The primary objective of the present invention is to provide a pet health management system whereby a care service provider (such as a veterinarian) at a remote site is provided with real-time information including a pet's images (dynamic or still images) and physical data so that the care service provider is enabled to preliminarily assess the pet's health conditions. Thereby, the disclosed system facilitates cooperation between care service providers and pet owners for pets' health management and disease prophylaxis despite of the existing problems related to geographic distance and veterinarian availability.

To achieve this and other objectives, a first management module is installed in a computer or a portable digital device of a pet owner, and a second management module is installed in computer or a portable digital device of a care service provider, wherein the first management module and the second management module are intercommunicated through preset communication systems and devices. The first management module mainly serves to acquire and instantly transmit a pet's images (dynamic or still images) as well as digital data to the second management module for the care service provider to observe so that the care service provider is enabled to preliminarily assess the pet's health conditions accordingly.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a system diagram of a pet health management system according to the present invention.

### DETAILED DESCRIPTION OF THE PREFERRED EMBODIMENT

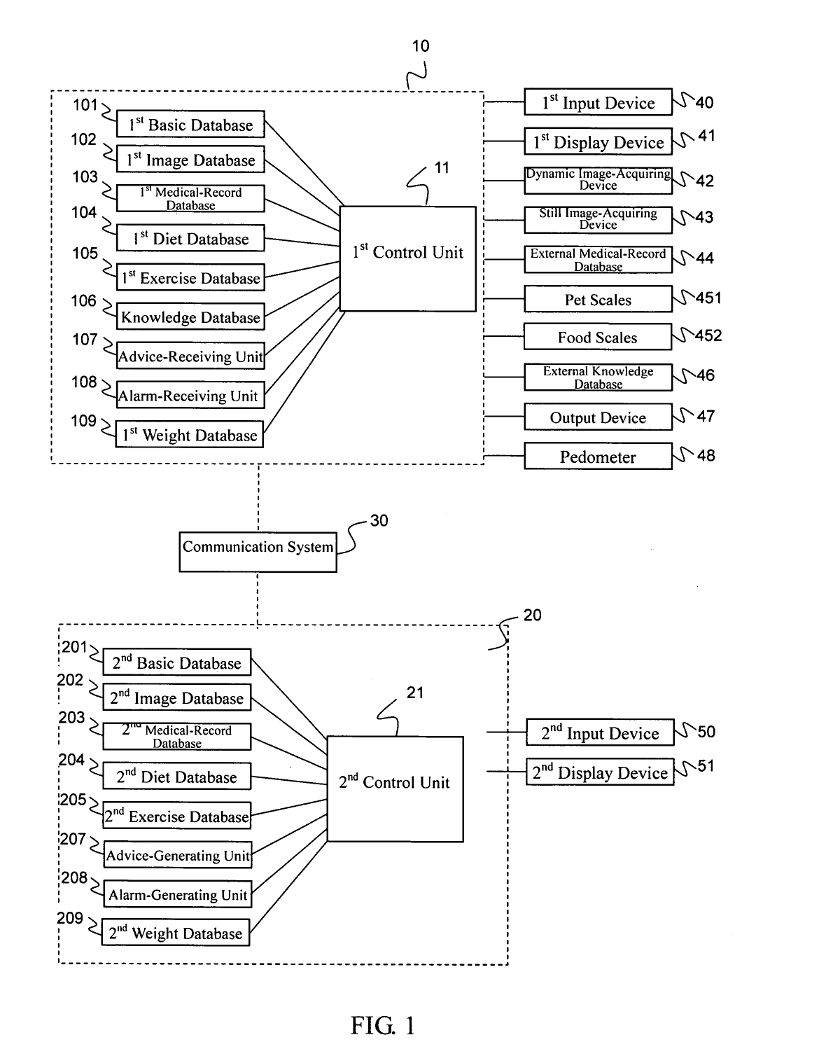

According to the present invention, a pet health management system, as shown in FIG. 1, comprises a first management module 10 installed at a pet owner's side and a second management module 20 installed at a care service provider's side. The first management module 10 and the second management module 20 are intercommunicated through preset communication systems and devices 30.

The first management module 10 is installed in a computer or a portable digital device of the pet owner for acquiring digital data related to health management of at least one pet. The first management module 10 includes: a first control unit 11, a first basic database 101, a first image database 102, a first medical-record database 103, a first diet database 104, a first exercise database 105, a first weight database 109, a knowledge database 106, an advice-receiving unit 107 and an alarm-receiving unit 108.

The first basic database 101 is coupled with the first control unit 11 and stores basic data of at least one pet. The basic data including the pet's type, nickname, sex, age, height and bearing state, are input through a first input device 40 that is coupled with the first management module 10. Contents of the basic data are displayed through a first display device 41 that is coupled with the first management module 10. The first control unit 11 transmits the basic data to the second management module 20.

The first image database 102 is coupled with the first control unit 11 and stores dynamic or still image files related to the pet. The image files are acquired by and transmitted from a dynamic image-acquiring device 42 or a still image-acquiring device 43 coupled with the first management module 10. Contents of the image files are displayed through the first display device 41. The first control unit 11 transmits the image files to the second management module 20.

The first medical-record database 103 is coupled with the first control unit 11 and stores medical records of the pet. The medical records include the pet's present history, past history, past drug use and present drug use. The medical records are input through the first input device 40 or from an external medical-record database 44 that is coupled with the first management module 10. The first display device 41 displays contents of the medical records. The first control unit 11 transmits the medical records to the second management module 20.

The first diet database 104 is coupled with the first control unit 11 and stores diet data of the pet. Contents of the diet data include types and amount of formula food, types and amount of non-formula food and daily water consumption. The diet data are input through the first input device 40 or from an electronic food scale 452 that serves to weight food and is coupled with the first management module 10. The first display device 41 displays contents of the diet data. The first control unit 11 transmits the diet data to the second management module 20.

The first exercise database 105 is coupled with the first control unit 11 and stores exercise data of the pet. The exercise data include the pet's exercise type and duration. The exercise data are input through the first input device 40 or from an external pedometer 48 that is carried by the pet and has an automatic data-transmission function. The first display device 41 displays contents of the exercise data. The first control unit 11 transmits the exercise data to the second management module 20.

The first weight database 109 is coupled with the first control unit 11 and stores weight data of the pet. The weight data are input through the first input device 40 or from an electronic pet scale 451 that serves to weight the pet and is coupled with the first management module 10. The first display device 41 displays contents of the weight data. The first control unit 11 transmits the weight data to the second management module 20.

The knowledge database 106 is coupled with the first control unit 11 and stores various knowledge of pet feeding. The knowledge data include information about pet feeding points, common pet diseases, symptoms, etc. The knowledge data are input through an external knowledge database 46 that is coupled with the first management module 10. The first display device 41 displays contents of the knowledge data.

The advice-receiving unit 107 coupled with the first control unit 11 serves to receive and store advice about pet care delivered from the second management module 20. The first display device 41 or an output device 47 coupled with the first management module 10 outputs contents of the advice.

The alarm-receiving unit 108 is coupled with the first control unit 11 and receives urgent notices coming from the second management module 20. The first display device 41 or the output device 47 coupled with the first management module 10 outputs the urgent notices. The urgent notice may be of an image or voice message as long as it is sufficient to notify the pet owner.

The second management module 20 is installed in a computer or a portable digital device of the care service provider for acquiring and storing digital data delivered from the first management module 10. The second management module 20 includes: a second control unit 21, a second basic database 201, a second image database 202, a second medical-record database 203, a second diet database 204, a second exercise database 205, a second weight database 209, an advice-generating unit 207, and an alarm-generating unit 208.

The second basic database 201 coupled with the second control unit 21 serves to receive and store the basic data delivered from the first management module 10 and displays the basic data through a second display device 51 coupled with the second management module 20.

The second image database 202 coupled with the second control unit 21 serves to receive and store the image files delivered from the first management module 10 and displays the contents of the image files at the second display device 51.

The second medical-record database 203 coupled with the second control unit 21 serves to receive and store the medical records delivered from the first management module 10 and displays the contents of the medical records at the second display device 51.

The second diet database 204 coupled with the second control unit 21 serves to receive and store the diet data delivered from the first management module 10 and displays the contents of the diet data at the second display device 51.

The second exercise database 205 coupled with the second control unit 21 serves to receive and store the exercise data delivered from the first management module 10 and displays the contents of the exercise data at the second display device 51.

The second weight database 209 coupled with the second control unit 21 serves to receive and store the weight data delivered from the first management module 10 and displays the contents of the weight data at the second display device 51.

The advice-generating unit 207 is coupled with the second control unit 21 and receives advice input through a second input device 50 that is coupled with the second management module 20. The second control unit 21 transmits the advice to the first management module 10.

The alarm-generating unit 208 is coupled with the second control unit 21 and generates urgent notices to be delivered to the first management module 10 according to the care service provider.

The first management module 10 and second management module 20 may be realized by using various electronic devices, such as PDA and computers. The dynamic image-acquiring device 42 may normally connect with the first management module 10 so as to transmit the dynamic images it acquires to the first management module 10 in a real-time manner. Furthermore, the first control unit 11 is enabled to control the image-acquiring device 42 to acquire dynamic images during preset time periods.

The electronic pet scale 451 is preferably settled at a sleeping place of the pet so that the weight data measured from the sleeping and still pet are can have ensured accuracy.

The electronic food scale 452 may be a known device that displays food names, weight, calorific capacity and nutrition contents. Before feeding the pet with a meal, water or any snack of a significant amount, the pet owner may use the electronic food scale 452 to control the pet's ingestion. Alternatively, the pet owner may put all food and water for the pet's daily consumption in separate containers that are coupled with the electronic food scale 452 so that the electronic food scale 452 can take measurement regularly to record the incidence and amount of the pet's ingestion and record the measured results in the first diet database 104 and transmit the measured results to the second management module 20 through the first control unit 11.

The electronic food scale 452 of another known type may allow the pet owner to designate the type of food. The electronic food scale 452 may automatically convert the information about food type and weight into information about calorific capacity and nutrition contents. The electronic food scale 452 may further transmit information about food name, weight, calorific capacity and nutrition contents to the first diet database 104 of the first management module 10 for record. Then the information may be transmitted to the second management module 20 for the care service provider's reference.

The primary objective of the present invention is to enable a care service provider (such as a veterinarian) at a remote site to preliminarily assess a pet's health conditions by studying the pet's images provided by the pet owner in a real-time manner. The dynamic image acquiring device 42 or the still image acquiring device 43 of a known type may be set to take the pet's images during preset time periods and save the images as digital files. The digital dynamic-image file shall present the pet's daily activity in a certain region (such as an indoor playing field) and the digital still-image file shall present the pet's facial and body appearances (local or entire), and looks of the pet's excrements. The digital files are stored in the first image database 102 and then transmitted to the second image database 202 of the second management module 20 through the first control unit 11. Thereby, the care service provider at a remote site is enabled to preliminarily assess the pet's health conditions by reading the contents of the image files and recognizing the pet's vitality, limb motions, overall appearance and looks of excrements with referring to the contents of the basic information, medical records and exercise data.

An additional function of the system of the present invention is to allow the remote care service provider who has preliminarily assessed the pet's health conditions to deliver advice information (such as feeding advice, exercise advise, drug use advice, etc.) to the first management module 10 for the pet owner's reference.

The remote care service provider may use the second input device 50 to edit the second medical-record database 203. The data in the second medical-record database 203 may be then transmitted to the first medical-record database 103 through the second management module 20 and the first management module 10, thereby updating the medical record in the first management module 10.

If the remote care service provider believes that the pet is or will soon be in life-threatening situation, he/she may use the alarm-generating unit 208 to send an urgent notice to the first management module 10 so as to notify the pet owner at the earliest possibility and allow the pet to have medical treatment as soon as possible.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A pet health management system, comprising:
a first management module, installed in a computer or a portable digital device at a pet owner end for acquiring and storing digital data related to health management of at least one pet; and
a second management module, installed in a computer or a portable digital device of a care service provider end, connected with the first management module through a communication system for acquiring and storing the digital data from the first management module.

2. The pet health management system of claim 1, wherein the first management module includes:
a first control unit;
a first basic database, coupled with the first control unit and storing basic data of the at least one pet, wherein the first control unit transmits the basic data to the second management module;
a first diet database, coupled with the first control unit and storing diet data of the pet, wherein the first control unit transmits the diet data to the second management module;
a first exercise database, coupled with the first control unit and storing exercise data of the pet, wherein the first control unit transmits the exercise data to the second management module; and
a first weight database, coupled with the first control unit and storing weight data of the pet, wherein the first control unit transmits the weight data to the second management module; and
the second management module includes:
a second control unit;
a second basic database, coupled with the second control unit serving to receive and store the basic data delivered from the first management module;
a second diet database, coupled with the second control unit serving to receive and store the diet data delivered from the first management module;
a second exercise database, coupled with the second control unit serving to receive and store the exercise data delivered from the first management module; and
a second weight database, coupled with the second control unit serving to receive and store the weight data delivered from the first management module.

3. The pet health management system of claim 2, further comprising a first image database coupled with the first control unit and a second image database coupled with the second control unit, wherein the first image database stores image files of the pet and the first control unit delivers the image files to the second management module; a first display device coupled with the first management module for displaying contents of the image files; the second image database serving to receive and store the image files delivered from the first management module, and displaying the contents of the image files through a second display device coupled with the second management module.

4. The pet health management system of claim 2, wherein, the image files of the first image database are acquired through an image-acquiring device coupled with the first management module.

5. The pet health management system of claim 4, wherein, the image-acquiring device acquires dynamic images.

6. The pet health management system of claim 4, wherein, the image-acquiring device acquires still images.

7. The pet health management system of claim 2, wherein, the diet data of the first diet database are acquired through an electronic food scale coupled with the first management module for weighting food.

8. The pet health management system of claim 2, wherein, the exercise data of the first exercise database are acquired through a pedometer that is carried by the pet and has an automatic data-transmission function.

9. The pet health management system of claim 2, wherein, the weight data of the first weight database are acquired through an electronic pet scale that serve to weight the pet and are coupled with the first management module.

10. The pet health management system of claim 2, further comprising a first medical-record database coupled with the first control unit and storing medical records of the pet, wherein the first control unit delivers the medical records to a second medical-record database coupled with the second control unit.

11. The pet health management system of claim 10, wherein the medical records of the first medical-record database are acquired from an external medical-record database coupled with the first management module.

12. The pet health management system of claim 2, further comprising a knowledge database coupled with the first control unit and storing various knowledge of pet feeding.

13. The pet health management system of claim 2, further comprising an alarm-generating unit coupled with the second control unit, wherein the alarm-generating unit generates an urgent notice and delivers the urgent notice to an alarm-receiving unit coupled with the first control unit.

14. The pet health management system of claim 2, further comprising an advice-receiving unit coupled with the first control unit and an advice-generating unit coupled with the second control unit, wherein the advice-generating unit generates advice and the advice-receiving unit receives the advice.
